(19) United States
(12) Patent Application Publication
(10) Pub. No.: US 2025/0060559 A1
(43) Pub. Date: Feb. 20, 2025

(54) HANDWHEEL CONTROL CIRCUIT FOR LENS FOCUSING

(71) Applicant: TILTA INC., Burbank, CA (US)

(72) Inventors: Guanjing LI, Shenzhen (CN); Wenping ZENG, Shenzhen (CN); Kefeng ZHOU, Shenzhen (CN)

(21) Appl. No.: 18/535,822

(22) Filed: Dec. 11, 2023

(30) Foreign Application Priority Data
Aug. 17, 2023 (CN) 2023222260833

(51) Int. Cl. G02B 7/04

(52) U.S. Cl. CPC G02B 7/04

(57) ABSTRACT

The present disclosure provides a handwheel control circuit for lens focusing, comprising a central processing chip, a master control chip, a keypad circuit, and a power system on/off circuit. The central processing chip is used to receive a power-on signal. The master control chip is communicatively connected to the central processing chip. The first end of the keypad circuit is connected to the central processing chip, for sending a power-on signal to the central processing chip for power supply. The first end of the power system on/off circuit is connected to the central processing chip, and the second end of the power system on/off circuit is connected to the second end of the keypad circuit. When the keypad circuit receives a power-on signal, it sends the signal to the power system on/off circuit, enabling the circuit to supply power to the central processing chip and the master control chip. The master control chip sends angle information data to the motor drive control circuit. The handwheel control circuit provided by the present disclosure sends angle information monitoring the rotation of the handwheel to the motor drive control circuit, achieving automatic control.

### CROSS-REFERENCE TO RELATED APPLICATIONS

The present Application for patent claims priority to and the benefit of pending Chinese Application No. 2023222260833, filed Aug. 17, 2023, and hereby expressly incorporated by reference herein as if fully set forth below in its entirety and for all applicable purposes.

### TECHNICAL FIELD

The present disclosure relates to the technical field of electronic circuit technology, specifically, a handwheel control circuit for lens focusing.

### INTRODUCTION

Currently, in the process of photography, photographers require different lens focus and focal lengths for different scenes. Typically, photographers adjust the camera lens focus manually by rotating the lens during the shooting process. However, camera equipment can be heavy, and continuous manual adjustment of the camera lens by the photographer can result in poor shooting efficiency and inconvenience.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some aspects of one or more implementations in a form as a prelude to the more detailed description that is presented later.

In view of the aforementioned issues, the present disclosure provides a handwheel control circuit for lens focusing to effectively address the existing problems of low shooting efficiency and inconvenience.

To achieve the above objectives, the present disclosure employs the following technical solutions:

The present disclosure provides a handwheel control circuit for lens focusing, comprising:
a central processing chip for receiving a power-on signal;
a master control chip is communicatively connected with the central processing chip;
a power system on/off circuit with a first end connected to the central processing chip;
a keypad circuit with a first end, which is connected to the central processing chip, and a second end, which is connected to a second end of the power system on/off circuit, for sending the power-on signal to the power system on/off circuit to supply power to the central processing chip and the master control chip, thereby enabling the master control chip to send angle information to the motor drive control circuit.

As an alternative embodiment, the handwheel control circuit further comprising:
a magnetic encoder circuit connected to the master control chip, for receiving angle information of the handwheel's rotation and converting it into electrical signals.

As an alternative embodiment, the handwheel control circuit further comprising:
a wireless module transmission circuit, with one end communicatively connected to the master control chip and the other end amplifying the electrical signal and transmitting it to the motor drive control circuit via an RF (Radio Frequency, RF) antenna.

As an alternative embodiment, the power system on/off circuit also includes a third end, which is connected to the central processing chip, such that when the central processing chip is powered on, the power system on/off circuit is reversely locked through the third end of the circuit, ensuring that the central processing chip and the master control chip of the handwheel control circuit are in the powered-on state.

As an alternative embodiment, the handwheel control circuit further comprising:
a first power supply circuit with a first end, which is connected to the central processing chip; and a second end, which is connected to the second end of the power system on/off circuit, for stabilizing the voltage within the power system on/off circuit when supplying power to the central processing chip;
a connection base circuit, with a first end connected to the second end of the keypad circuit and a second end connected to the second end of the power system on/off circuit, for control purposes.

As an alternative embodiment, the handwheel control circuit further comprising:
a second power supply circuit, one end of which is connected to the power system on/off circuit through the power source terminal, and the other end of the second power supply circuit connected to the master control chip;
a third power supply circuit, one end of which is connected to the power system on/off circuit through the power source terminal;
a touchscreen, one end of which is connected to the other end of the third power supply circuit, and the other end of the touchscreen connected to the master control chip;
wherein the second and third power supply circuits stabilize the power supply process of the power system on/off circuit.

As an alternative embodiment, the handwheel control circuit further comprising:
a voltage acquisition circuit, one end of which is connected to the power system on/off circuit through the power source terminal, and the other end connected to the master control chip, for collecting voltage data.

As an alternative embodiment, the handwheel control circuit further comprising:
a pogo pin interface circuit, the first end of which is connected to the power handle, the second end of which communicates with the central processing chip, and the third end of which is connected to the power system on/off circuit via a DC (Direct Current, DC) adjustment circuit.

As an alternative embodiment, the handwheel control circuit further comprising:
a type-c interface circuit, one end of which communicates with the master control chip for firmware upgrades;
a charging management circuit, the type-c interface circuit which is connected to the first end of the charging management circuit, the second end of which is connected to the central processing chip;
a battery, one end of which is connected to the third end of the charging management circuit, and the other end of which is connected to the fourth end of the power system on/off circuit;
wherein the charging management circuit displays a charging signal on the touchscreen when the battery is fully charged by receiving external power supply via the type-c interface circuit.

As an alternative embodiment, the handwheel control circuit further comprising:
a storage circuit connected to the master control chip for storing relevant control data;
a push-potentiometer connected to the central processing chip for switching the control device from a handwheel to a joystick for angle adjustment.

The present disclosure provides a handwheel control circuit for lens focusing, comprising a central processing chip, a master control chip, a keypad circuit, and a power system on/off circuit. The central processing chip is used to receive a power-on signal. The master control chip is communicatively connected to the central processing chip. The first end of the keypad circuit is connected to the central processing chip, for sending a power-on signal to the central processing chip for power supply. The first end of the power system on/off circuit is connected to the central processing chip, and the second end of the power system on/off circuit is connected to the second end of the keypad circuit. When the keypad circuit receives a power-on signal, the power system on/off circuit is reversely locked so that the handwheel control circuit is in the powered-on state. The master control chip sends angle information data to the motor drive control circuit. The handwheel control circuit provided by the present disclosure sends angle information monitoring the rotation of the handwheel to the motor drive control circuit, achieving automatic control.

To make the objectives, features, and advantages of this invention more clearly understood, exemplary embodiments and accompanying drawings are provided below for detailed explanation.

### BRIEF DESCRIPTION OF THE DRAWINGS

To clarify the technical solutions of the exemplary embodiments of the present disclosure, the following description provides a brief introduction to the drawings that need to be used in the embodiments. It should be understood that the following drawings only show some exemplary embodiments of the present disclosure and should not be construed as limiting its scope.

FIG. 1 is a schematic block diagram of the handwheel control circuit for lens focusing provided by the present disclosure.

FIG. 2 is a circuit diagram of the central processing chip provided by the present disclosure.

FIG. 3 is a circuit diagram of the master control chip provided by the present disclosure.

FIG. 4 is a circuit diagram of the keypad circuit provided by the present disclosure.

FIG. 5 is a circuit diagram of the power system on/off circuit provided by the present disclosure.

FIG. 6 is a circuit diagram of the connection base circuit provided by the present disclosure.

FIG. 7 is a circuit diagram of the first power supply circuit provided by the present disclosure.

FIG. 8 is a circuit diagram of the pogo pin interface circuit provided by the present disclosure.

FIG. 9 is a circuit diagram of the magnetic encoder circuit provided by the present disclosure.

FIG. 10 is a circuit diagram of the wireless module transmission circuit provided by the present disclosure.

FIG. 11 is a circuit diagram of the voltage acquisition circuit provided by the present disclosure.

FIG. 12 is a circuit diagram of the storage circuit provided by the present disclosure.

FIG. 13 is a circuit diagram of the push-potentiometer provided by the present disclosure.

Key Component Symbols are as follows:
100—Handwheel Control Circuit; 110—Central Processing Chip; 120—Master Control Chip; 130—Keypad Circuit; 140—Power System On/Off Circuit; 151—First Power Supply Circuit; 152—Second Power Supply Circuit; 153—Third Power Supply Circuit; 154—Power Source Terminal; 155—Touchscreen; 160—Connection Base Circuit; 170—pogo pin Interface Circuit; 171—DC Adjustment Circuit; 172—Power Handle; 173—type-c Interface Circuit; 175—Charging Management Circuit; 177—Battery; 179—External Power Supply; 180—Magnetic Encoder Circuit; 181—Motor Drive Control Circuit; 183—Wireless Module Transmission Circuit; 185—RF Antenna; 187—Voltage Acquisition Circuit; 190—Storage Circuit; 191—Push-Potentiometer.

### DETAILED DESCRIPTION

The following detailed description provides an explanation of specific embodiments of the present disclosure, where identical or similar reference numerals represent identical or similar components or components with identical or similar functions throughout.

It is vital to recognize that the specific embodiments delineated below are solely aimed at elucidating the present disclosure and do not seek to confine its scope.

In the following sections, we will provide a clear and comprehensive description of the technical solutions in the present disclosure, in conjunction with the accompanying figures. It should be noted that the embodiments described herein represent only a portion of the present disclosure's embodiments, rather than the entirety of them. Typically, the components of the present disclosure embodiments depicted and illustrated in these figures can be arranged and designed in various configurations. Therefore, the detailed description of the embodiments of the present disclosure provided in the figures is not intended to limit the scope of protection for the present disclosure but serves to illustrate selected embodiments of the present disclosure. Based on the embodiments of the present disclosure, all other embodiments that can be obtained by those skilled in the art without inventive effort are also encompassed within the scope of protection for the present disclosure.

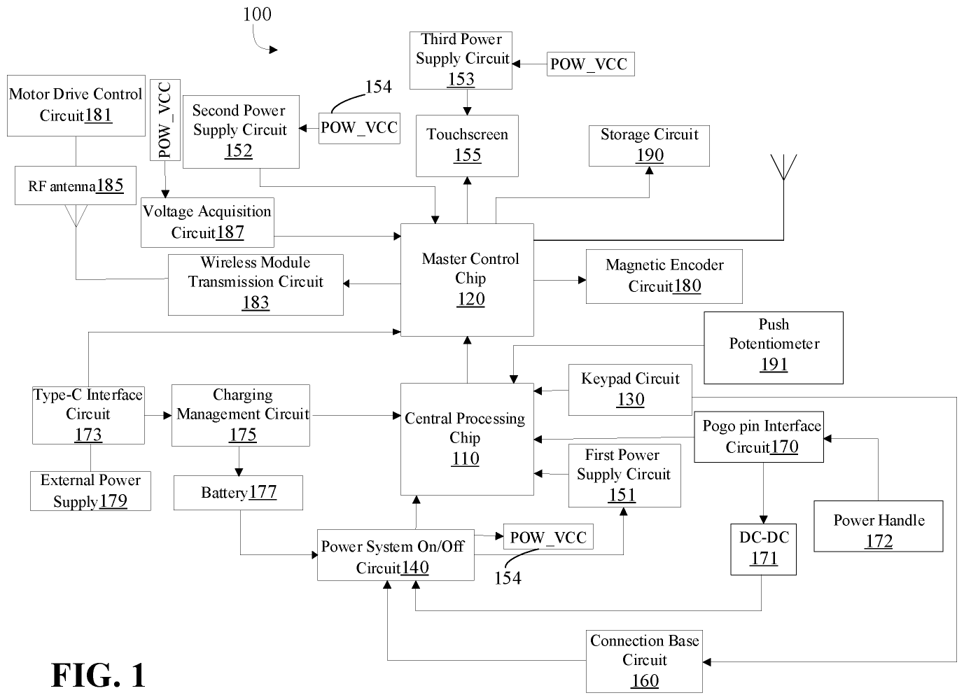

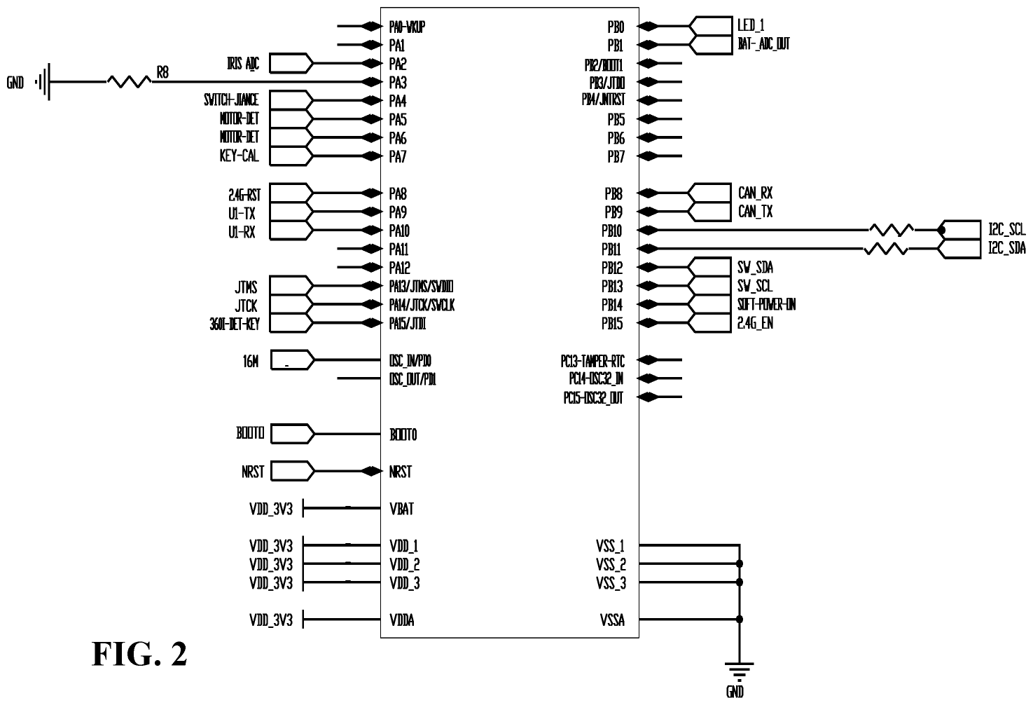

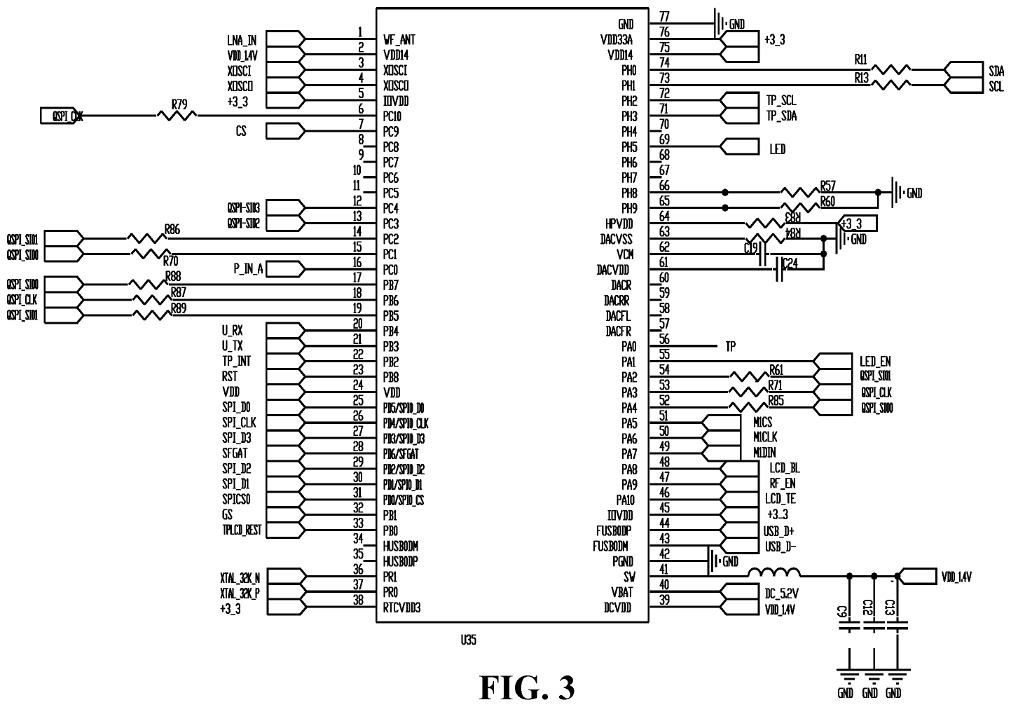

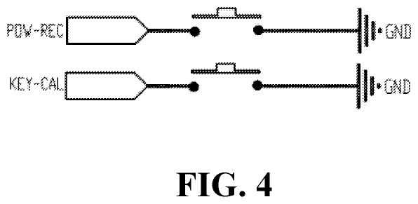

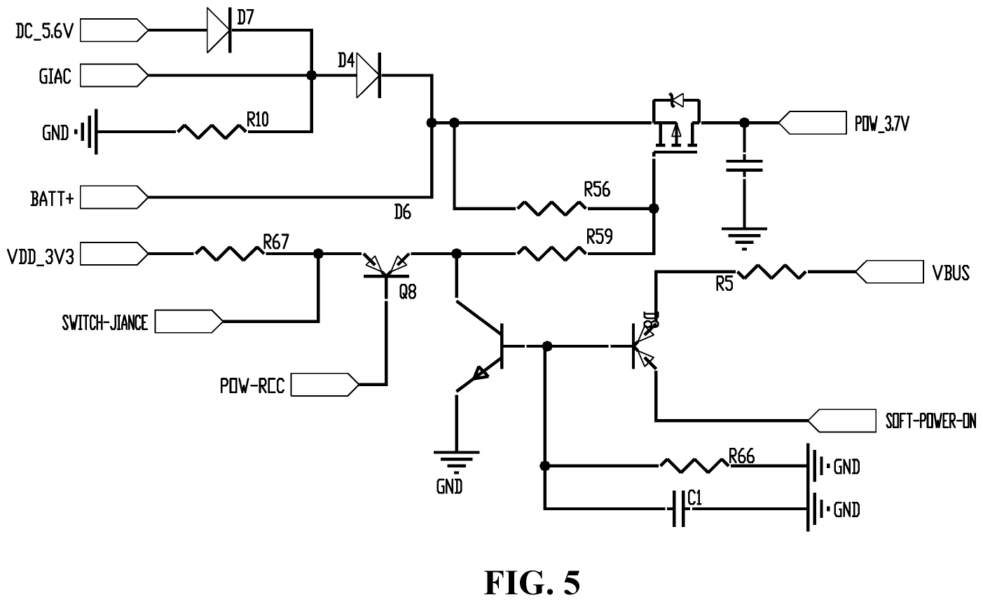

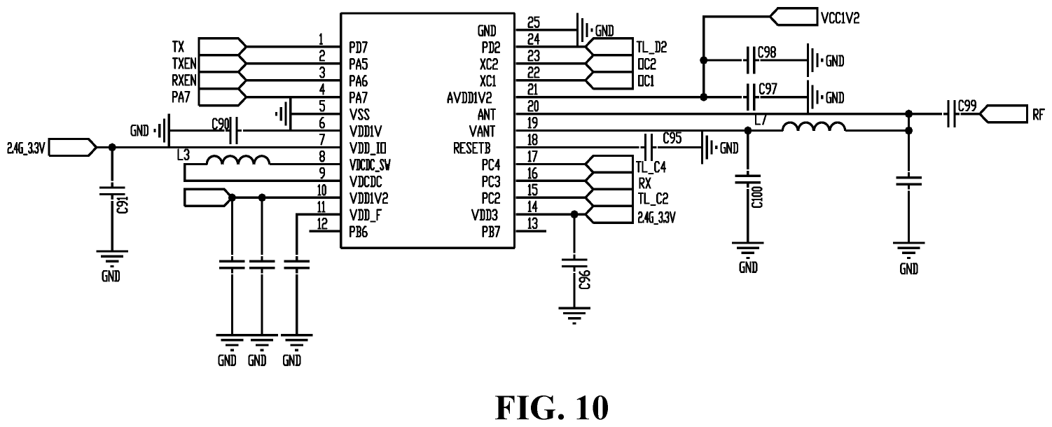

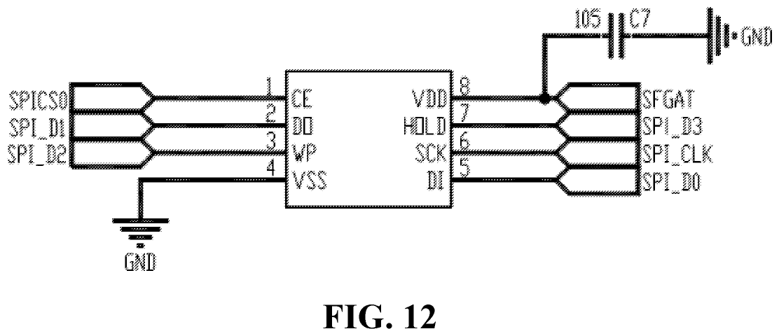

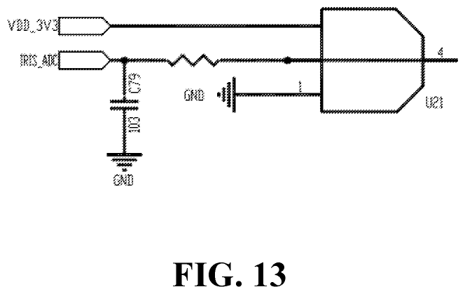

Please refer to FIG. 1-13 concurrently. The handwheel control circuit 100 includes a central processing chip 110, a master control chip 120, a keypad circuit 130, a power system on/off circuit 140, a first power supply circuit 151, a second power supply circuit 152, a third power supply circuit 153, a touchscreen 155, a connection base circuit 160, a pogo pin interface circuit 170, a DC adjustment circuit 171, a type-c interface circuit 173, a charging management circuit 175, a battery 177, an external power supply 179, a magnetic encoder circuit 180, a wireless module transmission circuit 183, an RF antenna 185, a voltage acquisition circuit 187, a storage circuit 190, and a push-potentiometer 191.

Referring again to FIGS. 1, 2, 3, 4, and 5, in further detail, the central processing chip 110 is used to receive a power-on signal input by the user. The master control chip 120 (referred to as the JL master control chip) communicates with the central processing chip 110 through the UART_AF communication protocol. The keypad circuit 130 includes a first end and a second end, where the first end of the keypad circuit 130 is connected to the central processing chip 110 (e.g., an RISC-V CH series chip). After receiving the power-on signal input by the user, the first end of the keypad circuit 130 sends the power-on signal to the central processing chip 110 for power supply. The power system on/off circuit 140 is equipped with a first end, a second end, a third end, and a fourth end. The first end of the power system on/off circuit 140 is connected to the central processing chip 110, and the second end of the power system on/off circuit 140 is connected to the second end of the keypad circuit 130. When the keypad circuit 130 receives the power-on signal, it sends the power-on signal to the power system on/off circuit 140, enabling the power system on/off circuit 140 to supply power to the central processing chip 110 and the master control chip 120. Consequently, the master control chip 120 sends angle information to the motor drive control circuit 181. In other words, the central processing chip 110 is connected to the power system on/off circuit 140 through an IO interface. This connection enables the central processing chip 110 to receive the power-on signal and lock on the power system on/off circuit 140 reversely in the powered-on state. The master control chip 120 sends angle information data monitoring the rotation of the handwheel to the motor drive control circuit 181. Additionally, the angle information data is also transmitted from the master control chip 120 via the wireless module transmission circuit 183 to the motor drive control circuit 181. It facilitates the focusing of the camera lens to reduce the inconvenience of manual focusing.

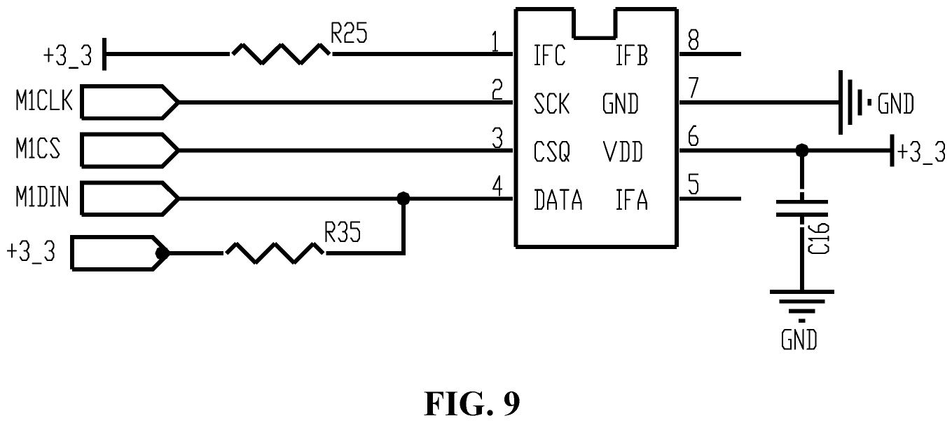

Referring again to FIG. 9, 10, in one embodiment, the magnetic encoder circuit 180 communicates with the master control chip 120 through the SPI interface using the SPI_AF communication protocol, allowing for high-precision measurement of the magnetic field strength perpendicular to the handwheel's rotation and coaxial with the output shaft. The magnetic encoder 180 converts angle information data into electrical signals and sends them via the master control chip 120, the wireless module transmission circuit 183, and the RF antenna 185 to the motor drive control circuit 181. In this way, the angle information data obtained by the receiving end is more accurate. In other words, the magnetic encoder circuit 180 monitors the angle of the handwheel's rotation, converts this information into electrical signals, and sends it via the master control chip 120 to the motor drive control circuit 181 to control the motor's rotation angle. The wireless module transmission circuit 183 has one end connected to the master control chip 120 through the TXRX interface, communicating via the UART_AF communication protocol. The other end of the wireless module transmission circuit 183 amplifies the signal and sends the angle information data to the motor drive control circuit 181 via a Zigbee 2.4 G network via RF antenna 185. When the wireless module transmission circuit 183 receives a high-level signal sent by the master control chip 120, the MOS transistor in the wireless module transmission circuit 183 opens, establishing a 2.4 G connection with the motor drive control circuit 181. This facilitates wireless communication between the motor drive control circuit 181 and the handwheel.

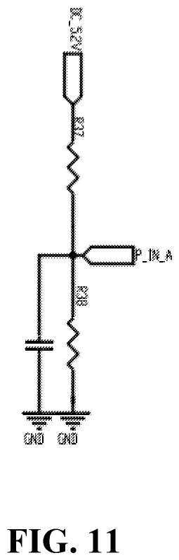

Referring again to FIGS. 11, 12, and 13, the voltage acquisition circuit 187 has one end connected to the power source terminal 154 of the power system on/off circuit 140 and the other end connected to the master control chip 120 to collect voltage data. In other words, the power system on/off circuit 140 is connected to the voltage acquisition circuit 187 through the P_IN_A interface, and the voltage acquisition circuit 187 is connected to the master control chip 120 to collect voltage levels and display them on the touchscreen 155. The storage circuit 190 (e.g., a FLASH storage device) connects to the master control chip 120 through the QSPI interface and is used to store relevant control data. The push-potentiometer 191 connects to the central processing chip 110 through the ADC interface and is used to switch the control device from a handwheel to a joystick angle adjustment. This enhances control accuracy and minimizes errors associated with manual focusing adjustments. Additionally, the filter mounting structure in this application, when disassembled, can be easily removed by opening the connecting ring, exposing the filter to the outside, making filter removal more convenient compared to traditional filter mounting.

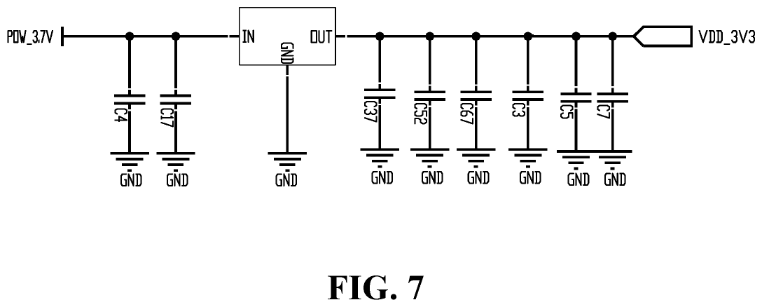

In reference to FIG. 7, in one embodiment, the first power circuit 151 comprises a first end and a second end. The first end of the first power circuit 151, which may be an LDO (Low Dropout Regulator), a type of low-voltage linear regulator, is connected to the central processing chip 110, while the second end is connected to the third end of the power supply system's on-off circuit 140. Upon receiving the power-on signal from the keypad circuit 130, the power supply system's on-off circuit 140 conducts the MOS tube and maintains a high level, effectively locking the handwheel control circuit 100 in the power-on state. In other words, when the power supply system's on-off circuit 140 receives the power-on signal from the keypad circuit, it provides power to the central processing chip 110 through the first power circuit 151. At this point, the MOS tube in the power supply system's on-off circuit 140 is in the conducting state, signifying successful power-on. Furthermore, when the central processing chip 110 subsequently issues a signal, it raises the voltage supplied to the power supply system's on-off circuit 140 to lock it in the power-on state, ensuring the stability of the integrated circuit.

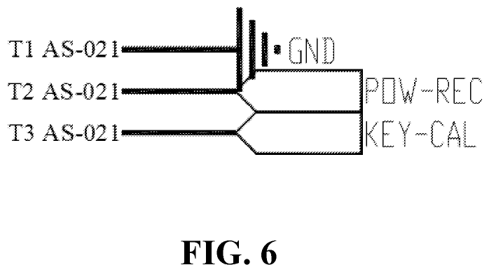

Referring to FIG. 6, the connection base circuit 160 has a first end connected to the second end of the keypad circuit 130, and the second end is linked to the second end of the power supply system's on-off circuit 140, thus controlling its on-off state, specifically, regulating the operation of the power supply system's on-off circuit 140. In other words, the key circuit 130 connects to the power supply system's on-off circuit 140 via the POW_REC interface of the connection base circuit 160 to control the on-off status of the power supply system's on-off circuit 140. More specifically, the connection base circuit 160 can accommodate multiple connection bases, with the POW_REC and KEY_CAL interfaces of the keypad circuit 130 connected to the T1, T2, and T3 of the connection base circuit 160. The POW_REC interface of the connection base circuit 160 is then linked to the POW_REC of the power supply system's on-off circuit 140. The keypad circuit 130 is connected to the connection base circuit 160, which in turn is connected to the power supply system's on-off circuit 140. This arrangement accommodates instances where space limitations in the structural design prevent the integration of different circuits. Consequently, different circuits are dispersed to adapt to the design of the product's structure. The second power supply circuit 152 is connected to the power supply system's on-off circuit 140 via the power terminal, while the other end of second power supply circuit 152 is linked to the main control chip 120. The third power supply circuit 153 is connected to the power supply system's on-off circuit 140 through the power terminal (POW_VCC). One end of the touchscreen 155 connects to the third power supply circuit 153, and the other end is linked to the main control chip 120. The second power supply circuit 152 and the third power supply circuit 153 are used to stabilize the power supply system's on-off circuit 140. In this particular embodiment, the first power supply circuit 151, the second power supply circuit 152, and the third power supply circuit 153 all share an identical circuit structure. In other words, the second power supply circuit 152 is connected to the power supply system's on-off circuit 140 via the power terminal POW_VCC. The second power supply circuit 152 is connected to the main control chip 120. The third power supply circuit 153 is connected to the power supply system's on-off circuit 140 through the power terminal (POW_VCC). Additionally, the third power supply circuit 153 connects to the touchscreen 155, and the communication between the main control chip 120 and the touchscreen 155 is conducted through the EMI-simulated QSPI_AF or IIC_AF communication protocol. The main control chip 120 is also linked to the central processing chip 110. This setup ensures that the power supply system's on-off circuit 140 supplies power to the entire system, and all voltages used in the entire system are regulated voltages, ensuring the stability of the handwheel component control circuit.

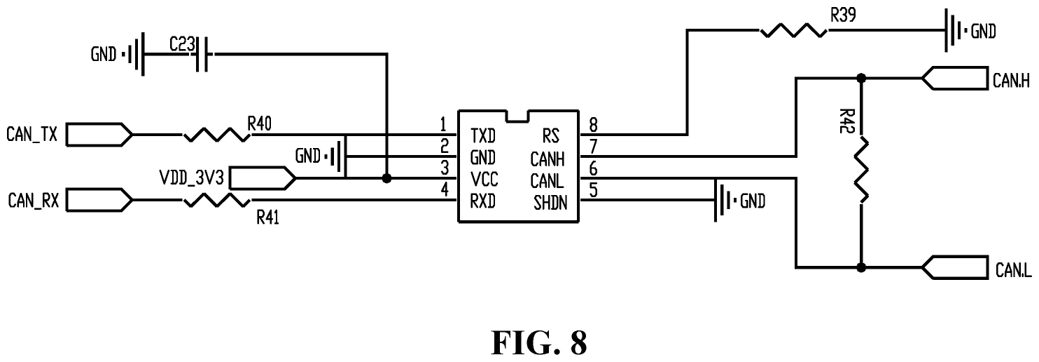

Referring to FIG. 8, in one embodiment, the pogo pin (Probe Module or Connector) interface circuit 170 has a first end connected to the power handle 172, the second end communicates with the central processing chip 110 at high speed through a CAN interface, and the third end is connected to the power supply system's on-off circuit 140 through a DC-DC circuit 171, also known as a direct current adjustment circuit. The pogo pin interface circuit 170 is used to connect an external power interface, such as a power handle 172. The left-side CAN interface of the pogo pin interface circuit 170 is linked to the central processing chip 110. This allows the pogo pin interface circuit 170 to communicate with the central processing chip 110 via the CAN interface. In parallel, another branch connects through the DC-DC circuit 171, responsible for adjusting the direct current voltage to an appropriate level, to supply power to the entire circuit system of the handwheel control circuit 100. This configuration ensures signal integrity and accuracy, allowing the product to function correctly in complex environments and effectively maintaining signal stability.

In one embodiment, one end of the type-c interface circuit 173 communicates with the main control chip 120 via the Type_C AF communication protocol to facilitate firmware upgrades. The other end of the type-c interface circuit 173 connects to the first end of the charging management circuit 175 through the Type_C PD communication protocol. The second end of the charging management circuit 175 is linked to the central processing chip 110. By using IIC communication, the charging management chip calculates Coulombic energy to accurately measure the handwheel's power level. One end of the battery 177 connects to the third end of the charging management circuit 175, while the other end connects to the fourth end of the power supply system's on-off circuit 140. When the charging management circuit 175 receives power from an external source 179 through the type-c interface circuit 173 to charge the battery 177 fully, it displays the charging signal on the touchscreen 155. In other words, during charging, the external power source 179 charges the battery 177 with energy through the type-c interface circuit 173. The battery 177 then supplies power to the power supply system's on-off circuit 140. Because the central processing chip 110 can communicate with the charging management circuit 175 and type-c interface circuit 173, it can instantly monitor the charging status. This information is displayed in real-time on the electronic screen, providing timely electrical information.

To make the objectives, technical solutions, and advantages of the present disclosure embodiment clearer, the above description combines the figures in the present disclosure embodiment to provide a clear and complete description of the technical solutions in the present disclosure embodiment. It is apparent that the described embodiments are just part of the present disclosure embodiment, not all embodiments. Typically, the components of the embodiments described and shown in the figures can be arranged and designed in various configurations.

Therefore, the detailed description of the embodiments of the present disclosure provided in the figures is not intended to limit the scope of the present disclosure being claimed, but merely represents selected embodiments of the present disclosure. Based on the embodiments of the present disclosure, all other embodiments obtained by those skilled in the art without making creative efforts belong to the scope of protection of the present disclosure.

What is claimed is:

1. A handwheel control circuit for lens focusing, comprising:
a central processing chip configured to receive a power-on signal;
a master control chip communicatively connected with the central processing chip;
a power system on/off circuit with a first end connected to the central processing chip; and
a keypad circuit comprising a first end connected to the central processing chip and a second end connected to a second end of the power system on/off circuit, the keypad circuit configured to send the power-on signal to the power system on/off circuit to supply power to the central processing chip and the master control chip, thereby enabling the master control chip to send angle information to a motor drive control circuit.

2. The handwheel control circuit according to claim 1, further comprising:
a magnetic encoder circuit connected with the master control chip, configured to receive angle information of a rotation of a handwheel and convert the angle information into an electrical signal.

3. The handwheel control circuit according to claim 2, further comprising:
a wireless module transmission circuit comprising a first end communicatively connected to the master control chip and a second end configured to amplify the electrical signal and transmit the electrical signal to the motor drive control circuit via an RF antenna.

4. The handwheel control circuit according to claim 1, wherein the power system on/off circuit includes a third end connected to the central processing chip, such that when the central processing chip is powered on, the power system on/off circuit is reversely locked through the third end of the power system on/off circuit, ensuring that the central processing chip and the master control chip of the handwheel control circuit are in the powered-on state.

5. The handwheel control circuit according to claim 4, further comprising:
a first power supply circuit including a first end connected to the central processing chip, and a second end connected to the second end of the power system on/off circuit, the first power supply circuit configured to stabilize a voltage within the power system on/off circuit when supplying power to the central processing chip;
a connection base circuit including a first end connected to the second end of the keypad circuit, and a second end connected to the second end of the power system on/off circuit, for control purposes.

6. The handwheel control circuit according to claim 1, further comprising:
a second power supply circuit including a first end connected to the power system on/off circuit through the power source terminal, and a second end connected to the master control chip;
a third power supply circuit including a first end connected to the power system on/off circuit through the power source terminal;
a touchscreen including a first end connected to a second end of the third power supply circuit, and a second end connected to the master control chip,
wherein the second power supply circuit and the third power supply circuit are configured to stabilize a power supply process of the power system on/off circuit.

7. The handwheel control circuit according to claim 6, further comprising:
a type-c interface circuit including a first end configured to communicate with the master control chip for firmware upgrades;
a charging management circuit including a first end connected to the type-c interface circuit, and a second end connected to the central processing chip; and
a battery including a first end connected to a third end of the charging management circuit, and a second end connected to a fourth end of the power system on/off circuit;
wherein the charging management circuit is configured to display a charging signal on a touchscreen when the battery is fully charged by receiving external power supply via the type-c interface circuit.

8. The handwheel control circuit according to claim 1, further comprising:
a voltage acquisition circuit including a first end connected to the power system on/off circuit through the power source terminal, and a second end connected to the master control chip, for collecting voltage data.

9. The handwheel control circuit according to claim 1, further comprising:
a pogo pin interface circuit including a first end connected to a power handle, a second configured to communicate with the central processing chip, and a third end connected to the power system on/off circuit via a DC adjustment circuit.

10. The handwheel control circuit according to claim 1, further comprising:
a type-c interface circuit including a first end configured to communicate with the master control chip for firmware upgrades;
a charging management circuit including a first end connected to the TYPEC interface circuit, and a second end connected to the central processing chip; and
a battery including a first end connected to a third end of the charging management circuit, and a second end connected to a fourth end of the power system on/off circuit,
wherein the charging management circuit is configured to display a charging signal on a touchscreen when the battery is fully charged by receiving external power supply via the type-c interface circuit.

11. The handwheel control circuit according to claim 1, further comprising:
a storage circuit connected to the master control chip for storing relevant control data; and
a push-potentiometer connected to the central processing chip and configured to switch from a handwheel to a joystick for angle adjustment.
